(19) United States
(12) Patent Application Publication
(10) Pub. No.: US 2009/0139442 A1
(43) Pub. Date: Jun. 4, 2009

(54) PIVOTABLE BUS CROSSING ARM

(75) Inventors: James C. Bradley, New Haven, IN (US); Christina Reber, Fort Wayne, IN (US); Rodney J. Klinger, Fort Wayne, IN (US); Joseph T. Penaloza, Fort Wayne, IN (US)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 11/949,106

(22) Filed: Dec. 3, 2007

(51) Int. Cl. B60Q 9/00

(52) U.S. Cl. 116/28 R

(57) ABSTRACT

A crossing arm for a vehicle having a longitudinal axis includes a body pivotably mounted onto the vehicle and configured for extension from a surface of the vehicle. The body has a free-standing, upwardly vertical position generally perpendicular to the longitudinal axis, and a horizontal position generally cantilevered from the vehicle and parallel to the longitudinal axis. An actuator is configured for pivoting the body from a vertical position to a horizontal position.

### BACKGROUND OF THE INVENTION

The present invention relates generally to an automatic barrier, and more particularly, relates to an automatic, pivotable barrier that is mounted on a vehicle.

Buses often have a crossing arm that extends out from the front of the bus generally parallel to the longitudinal axis of the bus. The crossing arm is typically automatically deployed by the driver when the bus is temporarily stopped to pick up or let off passengers, particularly children. The crossing arm is intended to prevent passengers from walking immediately in front of the vehicle. When the crossing arm is deployed, passengers tend to walk around the barrier, a distance away from the front of the bus, where the driver can see them.

The conventional crossing arms are typically actuated by a motor to pivot the arm from a first position, generally parallel to a front bumper of the bus, to a second position, generally parallel to the longitudinal axis of the bus. However, the linkage between the motor and the arm has a relatively high failure rate due to the typical loadings associated with a cantilevered system, including loadings imposed by the arm itself, external loadings on the arm, and vibration, among other things.

Thus, there is a need for an improved barrier that is simple to operate and less vulnerable to failure.

### BRIEF SUMMARY OF THE INVENTION

The above-listed needs are met or exceeded by the present crossing arm for a vehicle including a body pivotably mounted onto the vehicle and configured for extension from a surface of the vehicle. The body has a free-standing, upwardly vertical position generally perpendicular to the longitudinal axis, and a horizontal position generally cantilevered from the vehicle and parallel to the longitudinal axis. An actuator is configured for pivoting the body from a vertical position to a horizontal position.

A crossing arm has an extension axis that is parallel to a longitudinal axis of a vehicle and includes a body. The body is pivotably mounted onto the vehicle and configured for extension from a surface of the vehicle. The body has a vertical position generally perpendicular to the longitudinal axis, and a horizontal position generally cantilevered from the vehicle and parallel to the longitudinal axis. The body includes a generally cylindrical first portion and a blade portion extending from the first portion.

An alternate embodiment of crossing arm for a vehicle includes a body pivotably mounted onto the vehicle and configured for extension from a surface of the vehicle. The body has a vertical position generally perpendicular to the longitudinal axis, and a horizontal position generally cantilevered from the vehicle and parallel to the longitudinal axis. A support arm extends from the body and is received in a receiving structure mounted on the vehicle, and a spring joint is configured to permit the body to rotate about a support arm axis relative to the receiving structure.

### BRIEF DESCRIPTION OF THE DRAWINGS

FIG. 1A is a side plan view of a front portion of a bus having the present bus crossing arm in the vertical, retracted position;

FIG. 1B is a side plan view of the front portion of the bus having the bus crossing arm in the horizontal, extended position;

FIG. 2 is a perspective view of the bus crossing arm;

FIG. 3 is a schematic section view of the bus crossing arm taken along line A-A in FIG. 2;

FIG. 4 is a partial perspective view of the bus crossing arm showing the construction of the arm; and

FIG. 5 is a schematic section view of a spring joint for the crossing arm.

### DETAILED DESCRIPTION OF THE INVENTION

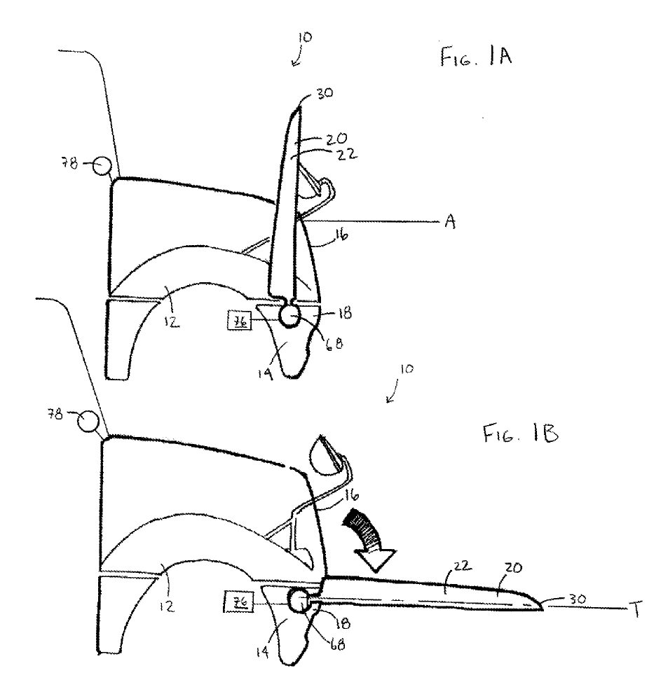

Referring to FIGS. 1A-5, a front portion of a bus is indicated generally at 10, and includes a wheel well cover 12 disposed at an exterior side surface 14 of the bus. Curving around from a front surface 16 to the side surface 14 of the bus is a bumper 18. The bus 10 also includes a crossing arm 20 attached to the side surface 14 preferably adjacent the bumper 18. Since the crossing arm 20 is preferably externally mounted to the side surface 14, it is more easily integrated on an existing bus 10. While the following description is made with respect to a bus 10, it is contemplated that the crossing arm 20 can be incorporated on any vehicle.

The crossing arm 20 is employed for the purpose of preventing people from passing too closely to the front of the bus 10 so that they can be observed crossing the path of the bus by the driver. The crossing arm 20 is pivotably moveable from a retracted, vertical position (FIG. 1A) to an extended, horizontal position (FIG. 1B). In the extended position, the crossing arm 20 extends generally parallel to the longitudinal axis “A” of the bus and along an extension axis “T”. The extension axis “T” is generally perpendicular to the bumper 18 and generally horizontal.

In the preferred embodiment of crossing arm 20, the crossing arm includes a body 22 having a first portion 24 that is generally cylindrical and hollow, and a blade portion 26. The body 22 is generally wedge-shaped, with the first portion 24 having a generally circular cross-sectional depth “D1. The blade portion 26 extends from the first portion 24 and has a tapering cross-sectional depth “D2”. Preferably, the body 22 has rounded corners at both the first portion 24 and the blade portion 26. The body 22 has a length “L” that extends from a bottom surface 28 to a distal end 30. Along the length “L”, the width “W” is wider at the bottom surface and tapers to the distal end.

The body 22 is preferably plastic, and more preferably is high impact plastic. However, any rigid lightweight material can be used. Further, it is contemplated that the body 22 can be either integrally formed or formed of discrete parts.

The first portion 24 has a generally cylindrical wall 32 that is preferably integrally formed with the body 22. The cylindrical wall 32 includes an exterior wall portion 34 defining an exterior body surface 36, and an interior body wall 38 that is disposed on the interior of the body 22.

The blade portion 26 preferably includes the interior body wall 38 and a first and a second side wall 42, 44 defining a chamber 46. Preferably disposed in the chamber 46 is a mesh core material 48 for providing the body 22 with additional strength, while reducing the overall weight of the body as compared to a solid-formed blade portion.

A support arm 50 is attached to or integrally formed with the body 22. In the preferred embodiment, a first end 52 of the support arm 50 is inserted into a slot 54 defined by the cylindrical wall 32 in the first portion 24 of the body 22. The support arm 50 preferably has a generally cylindrical body 56 to be received by the generally cylindrical wall 32 in a clearance fit, however other ways of attaching the support arm to the body 22 are contemplated. A second end 58 of the support arm 50 extends from the body 22 and preferably includes a connector 59.

The connector 59 is configured to be attached to or integrally formed with a ball joint 60. In the preferred embodiment, the connector 59 includes an attachment portion 62 that is attached to an exterior surface 64 of the ball joint 60, and a projecting portion 66 that is relieved from the exterior surface. The projecting portion 66 is preferably aligned with the body 22 of the crossing arm 20 in the length “L” direction.

The ball joint 60 is received in a corresponding receiving structure 68 that is preferably mounted on the vehicle 10. The receiving structure 68 includes a generally hollow spherical chamber 70 and a receiving slot 72. In the preferred embodiment, the receiving structure 68 has a generally spherical exterior surface 74.

The receiving slot 72 provides an opening to the chamber 70. When the ball joint 60 is received in the receiving structure 68, the support arm 50 and the connector 58 protrude through the slot 72. Further, the projecting portion 66 provides a guiding structure to facilitate the pivoting of the ball joint 60 in the receiving structure 68 from a vertical position to a horizontal position.

The crossing arm 20 is actuated from a vertical to a horizontal position (and back to the vertical position) by an actuator 76, as known in the art and commercially available. It is contemplated that the actuator 76 can be magnetically operated, fluid operated, or operated in any other way. In the preferred embodiment, the ball joint 60 pivots within the receiving structure 68 when the actuator 76 is actuated. However, other configurations to pivot the ball joint 60 with respect to the bus 10 using an actuator 76 are contemplated.

The driver (or other user) preferably initiates the actuator 76 with an input device 78 located in the cab of the bus or other vehicle 10. It is contemplated that the actuator 76 can be configured to actuate only when the bus 10 is stopped.

Preferably, the crossing arm 20 is near perfectly horizontal in the extended position when mounted on the side surface 14 of the vehicle 10 horizontally (with respect to the ground). In other words, the crossing arm preferably does not sag when it is extended.

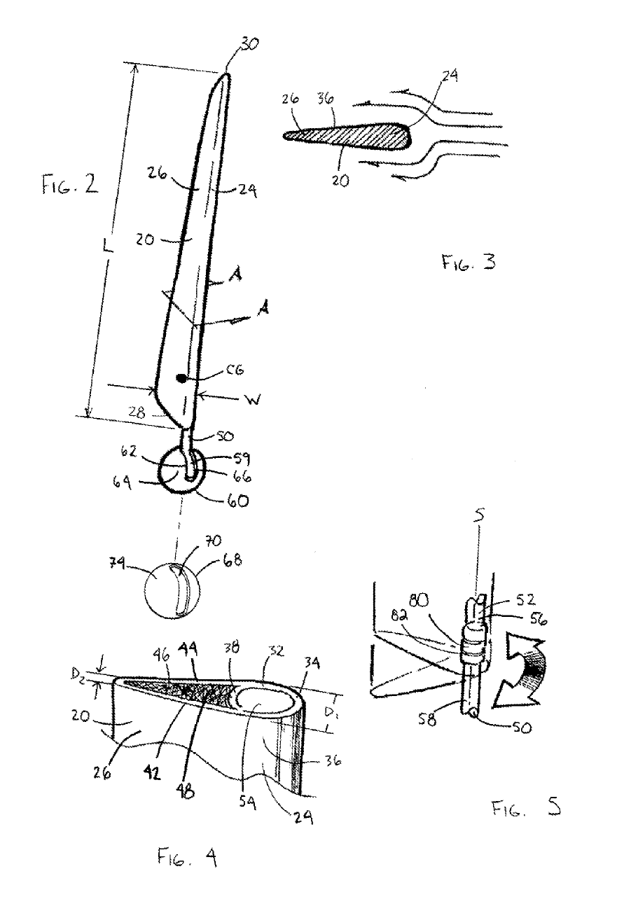

When the crossing arm 20 is not deployed in the horizontal position, it is retracted in the vertical position of FIG. 1A, with the crossing arm extending upwardly with respect to the ground and generally perpendicular the longitudinal axis “A” of the vehicle 10. FIG. 3 shows an example fluid flow pattern around the vertically stored crossing arm 20 while the bus 10 is traveling in the forward direction. The crossing arm 20 has an aerodynamic design to minimize the movement of the arm (due to fluid flow around the arm) during forward motion of the bus 10.

The storage of the crossing arm 20 in the vertical position, combined with the use of a ball joint 60 reduces the wear and tear on the crossing arm 20 associated with cantilevered systems since the weight of the body 22 is transferred vertically along the body to the ball joint 60. Further, the center of gravity “CG” of the crossing arm 20 is disposed on the body 22 nearer the ball joint 80 than the distal end 30 to reduce any potential moment arm.

The crossing arm 20 is not received into a storage structure when it is in the retracted, vertical position. Instead, the crossing arm 20 is configured to be free-standing, supported only by the ball joint 60 and the receiving structure 68.

When the crossing arm 20 is buffeted by a cross wind while in either the vertical or horizontal position, it is preferable for the crossing arm to remain straight and rigid along the length “L” of the body 22. Referring to FIG. 5, the crossing arm 20 is preferably provided with a spring joint 80 to permit the body 22 to swing relative to the second end 58 of the support arm 50.

Specifically, the first end 52 of the support arm 50 is preferably a separate member from the second end 58, and the two ends are linked with the spring joint 80. The spring joint 80 preferably includes a coil member 82 that is attached to both the first end 52 and the second end 58, and permits the relative rotation of the first end with respect to the second end about a support arm axis “S”. Alternately, other spring or hinge-like configurations are contemplated, such as a spring joint directly between the body 22 and the support arm 50. When the body 22 is subjected to cross-winds, the body and the first end 52 rotate in the direction indicated with the corresponding direction of the cross-wind. When the cross-wind ceases, the spring joint 80 returns the body 22 and the first end 52 to the original position with respect to the second end 58.

While particular embodiments of the present crossing arm have been shown and described, it will be appreciated by those skilled in the art that changes and modifications may be made thereto without departing from the invention in its broader aspects and as set forth in the following claims.

1. A crossing arm for a vehicle having a longitudinal axis, comprising:
a body pivotably mounted onto the vehicle and configured for extension from a surface of the vehicle, said body having a free-standing, upwardly vertical position generally perpendicular to the longitudinal axis, and a horizontal position generally cantilevered from the vehicle and parallel to the longitudinal axis;
an actuator configured for pivoting said body from a vertical position to a horizontal position.

2. The crossing arm of claim 1 further comprising a generally cylindrical first portion, and a blade portion extending from said first portion.

3. The crossing arm of claim 2 wherein said body is generally wedge-shaped, with said first portion having a generally circular cross-sectional shape and said blade portion having a tapering cross-sectional shape.

4. The crossing arm of claim 2 wherein said first portion has a generally cylindrical wall having an exterior wall portion defining an exterior body surface, and an interior body wall that is disposed on an interior of said body.

5. The crossing arm of claim 2 wherein said blade portion is formed of a first material that defines a chamber, and disposed in said chamber is a second material.

6. The crossing arm of claim 1 further comprising a support arm one of attached to or integrally formed with said body.

7. The crossing arm of claim 6 wherein said support arm has a first end attached to said body and a second end extending from said body.

8. The crossing arm of claim 7 wherein said second end includes a connector configured to be attached to or integrally formed with a ball joint.

9. The crossing arm of claim 8 wherein said ball joint is configured to be received in a receiving structure mounted on the vehicle.

10. The crossing arm of claim 6 further comprising a spring joint disposed on said support arm and configured to permit said body to rotate about a support arm axis relative to said second end of the support arm.

11. A crossing arm having an extension axis that is parallel to a longitudinal axis of a vehicle, the crossing arm comprising a body pivotably mounted onto the vehicle and configured for extension from a surface of the vehicle, said body having a vertical position generally perpendicular to the longitudinal axis, and a horizontal position generally cantilevered from the vehicle and parallel to the longitudinal axis, said body including a generally cylindrical first portion and a blade portion extending from said first portion.

12. The crossing arm of claim 11 further comprising a support arm extending from said body and configured to be received in a receiving structure mounted on the vehicle.

13. The crossing arm of claim 12 further comprising a spring joint disposed on said support arm and configured to permit said body to rotate about a support arm axis relative to said receiving structure.

14. The crossing arm of claim 12 further comprising a ball joint attached to said support arm, wherein said ball joint is received in said receiving structure.

15. The crossing arm of claim 11 wherein said body extends upward and is free-standing in said vertical position.

16. A crossing arm for a vehicle having a longitudinal axis, comprising:
a body pivotably mounted onto the vehicle and configured for extension from a surface of the vehicle, said body having a vertical position generally perpendicular to the longitudinal axis, and a horizontal position generally cantilevered from the vehicle and parallel to the longitudinal axis;
a support arm extending from said body and received in a receiving structure mounted on the vehicle; and
a spring joint configured to permit said body to rotate about a support arm axis relative to said receiving structure.

17. The crossing arm of claim 16 further comprising a ball joint.

18. The crossing arm of claim 16 wherein said body includes a generally cylindrical first portion and a blade portion extending from said first portion.

19. The crossing arm of claim 16 further comprising an actuator configured for pivoting said body from a vertical position to a horizontal position.

20. The crossing arm of claim 19 further comprising an input device disposed inside the vehicle for actuating said actuator.
